(19) United States
(12) Patent Application Publication
(10) Pub. No.: US 2015/0332600 A1
(43) Pub. Date: Nov. 19, 2015

(54) METHOD AND SYSTEM FOR BUILDING AND SCORING SITUATIONAL JUDGMENT TESTS

(71) Applicants: Varun Aggarwal, Gurgaon (IN); Steven Stemler, Middlotown, CT (US)

(72) Inventors: Varun Aggarwal, Gurgaon (IN); Steven Stemler, Middlotown, CT (US)

(21) Appl. No.: 14/674,239

(22) Filed: Mar. 31, 2015

(30) Foreign Application Priority Data
Mar. 31, 2014 (IN) 934/DEL/2014

(51) Int. Cl. G09B 7/06

(52) U.S. Cl. CPC G09B 7/06

(57) ABSTRACT

A method and system for building a situational judgment test implemented on non transitory computer storage media is disclosed. The method includes the steps for providing one or more test situations; providing multiple options to address each of one or more test situations, wherein multiple options comprise at least one of a correct worst answer, and a correct best answer; and providing a selectable feature for selecting either a worst response or a best response by a user. The test situation, the multiple options, and the selectable feature are provided using a user interface capable of user interaction.

This is a complete specification of the provisional application number 934/DEL/2014 filed on 31 Mar. 2014 with the Indian Patent Office.

### FIELD OF THE INVENTION AND USE OF INVENTION

The invention relates generally to the field of situational judgment tests that are useful in the field of education and job related hiring and evaluations and more specifically for selection of candidates for professional courses and for selection of suitable professionals for different roles and responsibilities in different organizations.

### PRIOR ART AND PROBLEM TO BE SOLVED

SJTs are written descriptions or video depictions of job-relevant situations that involve some sort of dilemma or conflict. The scenarios are typically derived from a job analysis study of critical skills required for a particular job (Schneider & Konz, 1989). SJTs have their roots in the critical incidents technique (Flanagan, 1954) in which participants are interviewed and asked to come up with job-relevant incidents, the responses to which distinguish high-performing employees from low-performing employees. Scenarios are then developed based on these incidents and a new set of participants are presented with the scenarios and asked to evaluate different ways of responding. The responses may be short answer, but more typically participants are given a finite number of potential responses and asked to rate the quality of the response option on a Likert scale

Situational judgment tests (SJT) have been used to measure different competencies, practical intelligence and people interaction skills among other things. The scores of the tests are used for various purposes including recruitment, promotion decisions and counseling. Several studies show that scores on situational judgment tests have strong correlation with performance metrics and are valid predictors of performance for certain job profiles.

In a situational judgment item (question), a situation is provided as explained herein above and the test-taker has to choose, among a set of options, the right way of handling the situation. He/she may also be asked to rank the options according to their suitability in handling the given situation. The item is then scored based on whether the person chose the correct option for the right way to handle the situation. The choice of situation depends on the skill the candidate is being tested for. For e.g. if it is a sales SJT test then the candidate will be presented with scenarios that a sales professional usually encounters during his/her course of work, similarly if it's a Customer Service SJT then the candidate will be presented with scenarios commonly encountered by customer service professionals.

The problem with approaches to scoring SJTs that currently exist is that there is generally more than one right way of responding to the situation which depends on the role, organization culture, geographies, etc. Due to this, for each organization/role, the correct answers have to be re-determined. This is done by taking input from stakeholders and/or high performers in the given role/company.

Consequently, one is not able to develop standardized situational judgment tests which may be used across roles and companies. The SJT based test has to be re-built and re-calibrated for every organization and role.

### SUMMARY OF THE INVENTION

In one aspect, a for building a situational judgment test implemented on non transitory computer storage media is disclosed. The method includes the steps for providing one or more test situations; providing multiple options to address each of one or more test situations, wherein multiple options comprise at least one of a correct worst answer, and a correct best answer; and providing a selectable feature for selecting either a worst response or a best response by a user. The test situation, the multiple options, and the selectable feature are provided using a user interface capable of user interaction.

In another aspect the invention provides a system for building and scoring a situational judgment test. The system includes a test situation module comprising textual content for one or more test situations and associated multiple options to address each of one or more test situations, multiple options comprise at least one of a correct worst answer, and a correct best answer; a user interaction module for providing the test situation, the multiple options and a selectable feature for selecting either a worst response or a best response by a user as a user response and configuring the user interaction module to receive the user response through one or more interactive features; and a score generator module for generating a score based on a selection of the correct worst answer. The test situation module, the user interaction module and the score generator module are implemented on a non-transitory computer storage media.

### DRAWINGS

These and other features, aspects, and advantages of the present invention will become better understood when the following detailed description is read with reference to the accompanying drawings in which like reference numerals represent corresponding parts throughout the drawings, wherein:

FIG. 1 is a flowchart showing exemplary steps for a method for building a situational judgment test according to one aspect of the invention; and

FIG. 2 is a diagrammatic representation for a system for method for building and testing a situational judgment test according to another aspect of the invention.

### DETAILED DESCRIPTION OF THE INVENTION

As used herein and in the claims, the singular forms “a,” “an,” and “the” include the plural reference unless the context clearly indicates otherwise.

The method and system for building and scoring situational judgment tests described herein are such that they need not be re-calibrated, but instead can be used across organizations and roles. In this technique the tests are designed to determine whether the candidate can identify the wrong strategy to handle the situation, which should never be exercised to handle the situation (as determined by theory and/or experts). Thus the questions are designed such that there is at least one option (option “wa” [correct worst answer]) which represents a bad strategy to handle the situation. This option construction in one exemplary implementation is based on dark trait theory (Veselka, Aitken Schermer, & Vernon, 2012), a response exhibited by people with traits such as arrogance, narcissism, self-promotion, emotional coldness, duplicity, aggressiveness, and Machiavellianism. Scoring is done based on the choice of the worst strategy answer by a person viz. this option.

In an exemplary implementation the candidate is asked to endorse both the best strategy to handle the situation and the worst strategy. Two kinds of scores are created. In the first score (best score), the candidate gets a +1 if he identifies the option “wa” as the worst response to handle the situation and 0 if he/she endorses any other option as the worst response to handle the situation. A second score (worst score) is created, where the candidate gets a −1 if he marks option “wa” as best strategy and 0 otherwise. The first score consistently shows high correlation with performance ratings across organizations and job-roles, followed by the second score. On the other hand, other scores created based on the identification of best (or right) strategy to handle the situation do not show consistently high validity.

Both best and worst scores are calculated based on the agreed upon and designated worst answer. A sum of these new best and worst scores may be interpreted as follows: If the candidate identifies the designated worst answer he is excellent, if he doesn't he is average, but if he thinks the designated worst answer is the best response, she/he is disqualified. This is the score that measures whether the person knows ‘what not to do’.

SJTs can be scored by the first score, the second score (as described above) or a combination of the two. The combination (cross total) can be a simple sum or a weighted sum of these two scores, the weights being determined by an expert or empirically. The item level score can also be mapped to a new score by IRT modeling, rasch modeling and/or other techniques.

Such SJTs which are constructed with having one (or more) option(s) representing a bad strategy (correct worst answer) to handle the situation and scoring based on the two scoring strategies defined above, can be used in a standardized way across job roles/companies for recruitment/promotion and used for providing feedback to test-takers. They need not be customized according to job or company needs.

The situational judgment test as described herein is implemented through use of appropriate software and hardware machines and apparatus where the computer programs for implementing the necessary functionalities of the techniques, and the specific modules described herein are implemented on a non-transitory, tangible computer readable storage medium.

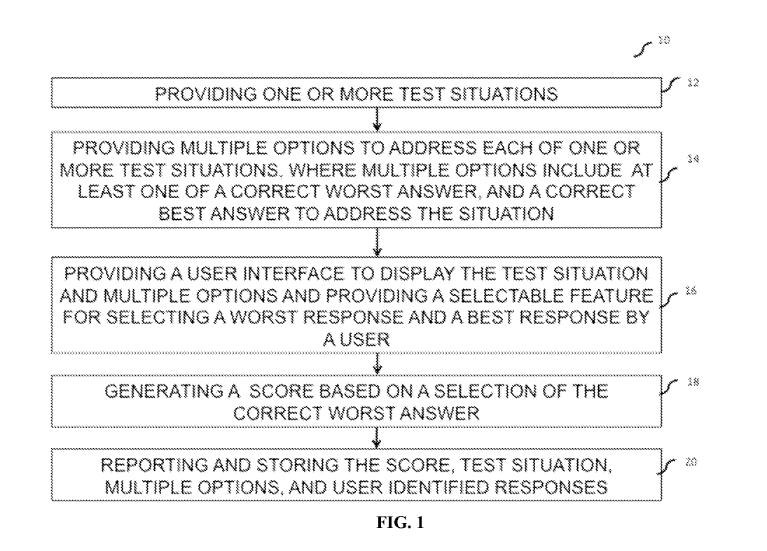

The above described technique is shown as flowchart 10 in FIG. 1 for a method for building a situational judgment test. The method comprises a step 12 for providing one or more test situations; and a step 14 for providing multiple options to address each of one or more test situations, where the multiple options include at least one of a correct worst answer, and a correct best answer. The test situation and the multiple options are provided using a user interface capable of user interaction. The method includes a step 16 for providing a selectable feature for selecting either a worst response or a best response by a user as a user response.

As explained above the method then includes a step 18 for generating a score based on a selection of the correct worst answer as explained above. The method also includes a step 20 for generating a test report based on the score. The method includes a step 22 for storing the test situation and multiple options in a test database, storing a user identification and associated score in a user score database. The method includes a step 24 for displaying the score on a user interactive interface or communicating the score to an external communication device.

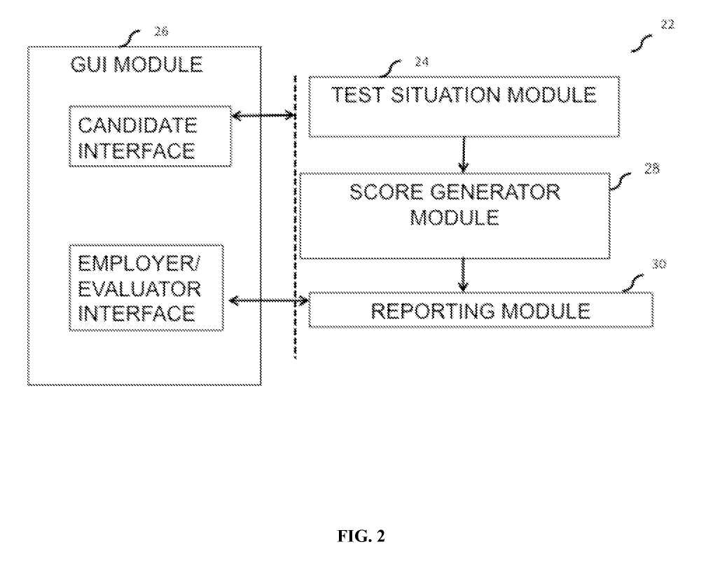

FIG. 2 shows a system 22 for building and scoring a situational judgment test. A test situation module 24 is built that includes textual content for one or more test situations and associated multiple options to address each of one or more test situations, where at least one of the multiple options is a correct worst answer to address the situation, and where at least one of the multiple options is a correct best answer to address the situation. A user interaction module (Graphical User Interface—GUI Module) 26 is provided for providing the test situation and the multiple options to a user display device. The user interaction module includes a candidate interface and a employer/Evaluator interface, where the user is a candidate and an evaluator respectively. The user interface module is configured to receive user response through one or more interactive features that may include speech response and text response.

A score generator module 28 is provided for generating a score based on a selection of the correct worst answer as explained above. The system includes a reporting module 30 for generating a report based on the score. The user identification module comprises a user identification and associated score.

### Examples

Some exemplary scenarios of scoring using the present technique are described herein below:

### Type I

### Scoring Scale: −1, 0, 1

a. Candidate marks the correct best answer as Worst=−1
b. Candidate marks the correct worst answer as Best=−1
c. Candidate marks the correct best answer as Best=+1
d. Candidate marks the correct worst answer as Worst=+1
e. All other cases=0
In this scoring the test taker is penalized (−1) for marking the correct best answer as worst and vice versa. And is awarded a bonus+1 for marking the Best and Worst option correctly. In all other cases the test taker gets a zero.

### Type II

### Scoring Scale: 0, 1

a. Candidate marks correct best answer as Best=+1
b. Candidate marks correct worst answer=+1
c. All other cases=0
d. In this scoring the candidate is awarded a bonus+1 for marking the Best and Worst option correctly. In all other cases the test taker gets a zero. There is no penalization.

### Type III

### Scoring Scale: −1, 0

a. Candidate marks the correct best answer as Worst=−1
b. Candidate marks the correct worst answer as Best=−1
c. All other cases=0
In this scoring the test taker is penalized (−1) for marking the best option as worst and vice versa. In all other cases the test taker gets a zero. There are no bonus points for marking the right options.

### Type IV

This is a combination of Type 2 and Type 3 scoring.
a. Candidate marks correct worst answer as Best=−1
b. Candidate marks correct worst answer as worst=+1
c. All other cases=0
In this scoring the candidate is penalized for marking the worst option as the best option but not vice versa. And is awarded a bonus+1 for marking the worst option correctly.

### EXPERIMENT

Participants in this experiment were given the following instructions:

“In this module, you will be provided with various situations one faces in the corporate environment. Based on the situation provided, we wish to understand what action you will take in the given situation. You have to choose two options: (a) The most desirable action amongst the options provided; and (b) The least desirable action amongst the options provided. There is no correct or incorrect answer in this module. It basically solicits your opinion in handling these situations. There are a total of 22 questions in this section, which have to be answered in 35 minutes. All questions have to be answered and you cannot review any question, once you have moved on to the next question.”
The instructions for the managerial SJT are presented below:
“In this module, you will be provided with various situations that one faces in the corporate environment. Based on the situation provided, we wish to understand what action you will take in the given situation. You have to choose two options:
a. The best action amongst the options provided.
b. The worst action amongst the options provided.
There is no correct or incorrect answer in this module. It basically solicits your opinion in handling these situations. There are a total of 20 questions in this section which have to be answered in 35 minutes.”

For each salesperson in the organization, the employer sets particular sales targets for each month. Thus, the dependent variable we were trying to predict was percentage of sales targets that were met by each employee who took our SJT. The sales targets were calculated as the mean of the last two quarters from when the study was conducted.

Methods

The sales SJT was individually administered online via the Aspiring Minds assessment engine O. Participants were required to take the assessment at an authorized testing center. The assessment consisted of 22 scenarios, each of which contained 4-5 response options. The SJT took approximately 35 minutes to complete. Participants were required to take the test as instructed by their employer. Data on the percentage of sales targets achieved was obtained from the reporting manager who gathered information from the company information system.

Sample

Participants in Study 1 were drawn from a 400 person company in India. All of the sales people in the organization with experience levels ranging from six months to two years at the company were asked by their managers to participate in the assessment. The final sample proportionally represented the company based on gender, age, educational qualifications, and performance.

Results

A total of 50 participants (45 males, 5 females) completed the sales SJT. The average age of participants was 26 years old (SD=3.5 years) and the participants had worked for the organization an average of 11 months (SD=5.1 months). The highest level of education in the sample was an MBA, with 84% of participants holding a MBA.

When the data were scored using the traditional algorithm found in the literature (−1,0,1), with a single score generated from this approach, the variable was not a statistically significant predictor of percent of target sales (r=0.27, ns). When we consider the Traditional Worst (−1,0,1) separately, it correlates significantly with the output (r=0.28, p<0.05).

Among all approaches to do scoring the worst response chosen by the candidate, the new approach as outlined in the invention has the highest and significant correlation with output (r=0.33,p<0.05). Similarly, our approach to score the best response, based on only the designated worst answer, Opposite Best (−1,0) shows the highest correlation (r=0.25, ns). among best scoring approaches, however not significant. Among all the individual scoring approaches (either of WR or BR), the Worst (0,1) approach does the best. The new total score, that combines the Worst (0,1) and Opposite Best (−1,0), only based on a designated worst answer, outperforms all other scores in terms of its correlation with output (r=0.36, p<0.05).

Thus the results were only statistically significant predictors when one considers the ability to identify the “worst” answer as a skill that is separate from the ability to identify the “best” response. Furthermore, this prediction becomes better if the concept of a designated correct best answer is not there and the scoring is done only on basis of a designated worst answer. Both the worst response and best response graded this way show higher correlation as compared to their counterparts. Their sum outperforms all other scoring methods.

The present invention thus addresses the shortcomings of the traditional prior art approach of conceptualizing the ability to correctly identify bad and good response options to SJTs as two endpoints along a single latent trait. There are multiple good ways of handling a situation and it changes with roles, organizations and cultures. Instead, the invention uses the ability to identify bad responses as a truer indicator of the success of the SJTs in accurately selecting the appropriate candidate across different geographic and cultural backgrounds.

The system and method of the invention may be accessible through an application interface on a networked computer or through any other electronic and communication device such as a mobile phone connected via wires or wirelessly which may use technologies such as but not limited to, Bluetooth, WiFi, Wimax. In one example the system and method of the invention are implemented through a computer program product residing on a machine readable medium, where the computer program product is tangibly stored on machine readable media.

The different users (candidates, crowdsource volunteers, administrators, and others) may enter or communicate data or request through any suitable input device or input mechanism such as but not limited to a keyboard, a mouse, a joystick, a touchpad, a virtual keyboard, a virtual data entry user interface, a virtual dial pad, a software or a program, a scanner, a remote device, a microphone, a webcam, a camera, a fingerprint scanner, pointing stick.

The described embodiments may be implemented as a system, method, apparatus or article of manufacture using standard programming or engineering techniques related to software, firmware, hardware, or any combination thereof. The described operations may be implemented as code maintained in a “computer readable medium”, where a processor may read and execute the code from the computer readable medium. A computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. The code implementing the described operations may further be implemented in hardware logic (e.g., an integrated circuit chip, Programmable Gate Array (PGA), Application Specific Integrated Circuit (ASIC), etc.). Still further, the code implementing the described operations may be implemented in “transmission signals”, where transmission signals may propagate through space or through a transmission media, such as an optical fibre, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a computer readable medium at the receiving and transmitting stations or devices. An “article of manufacture” comprises computer readable medium, hardware logic, or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the present invention, and that the article of manufacture may comprise suitable information bearing medium known in the art.

A computer program code for carrying out operations or functions or logic or algorithms for aspects of the present invention may be written in any combination of one or more programming languages which are either already in use or may be developed in future, such as but not limited to Java, Smalltalk, C++, C, Foxpro, Basic, HTML, PHP, SQL, Javascript, COBOL, Extensible Markup Language (XML), Pascal, Python, Ruby, Visual Basic .NET, Visual C++, Visual C#.Net, Python: Delphi, VBA, Visual C++ .Net, Visual FoxPro, YAFL, XOTcI, XML, Wirth, Water, Visual DialogScript, VHDL, Verilog, UML, Turing, TRAC, TOM, Tempo, Tcl-Tk, T3X, Squeak, Specification, Snobol, Smalltalk, S-Lang, Sisal, Simula, SGML, SETL, Self, Scripting, Scheme, Sather, SAS, Ruby, RPG, Rigal, Rexx, Regular Expressions, Reflective, REBOL, Prototype-based, Proteus, Prolog, Prograph, Procedural, PowerBuilder, Postscript, POP-11, PL-SQL, Pliant, PL, Pike, Perl, Parallel, Oz, Open Source, Occam, Obliq, Object-Oriented, Objective-C, Objective Caml, Obfuscated, Oberon, Mumps, Multiparadigm, Modula-3, Modula-2, ML, Miva, Miranda, Mercury, MATLAB, Markup, m4, Lua, Logo, Logic-based, Lisp (351), Limbo, Leda, Language-OS Hybrids, Lagoona, LabVIEW, Interpreted, Interface, Intercal, Imperative, IDL, Id, ICI, HyperCard, HTMLScript, Haskell, Hardware Description, Goedel, Garbage Collected, Functional, Frontier, Fortran, Forth, Euphoria, Erlang, ElastiC, Eiffel, E, Dylan, DOS Batch, Directories, Declarative, Dataflow, Database, D, Curl, C-Sharp, Constraint, Concurrent, Component Pascal, Compiled, Comparison and Review, Cocoa, CobolScript, CLU, Clipper, Clean, Clarion, CHILL, Cecil, Caml, Blue, Bistro, Bigwig, BETA, Befunge, BASIC, Awk, Assembly, ASP, AppleScript, APL, Algol 88, Algol 60, Aleph, ADL, ABEL, ABC, or similar programming languages or any combination thereof.

The different modules referred herein may use a data storage unit or data storage device that is selected from a set of but not limited to USB flash drive (pen drive), memory card, optical data storage discs, hard disk drive, magnetic disk, magnetic tape data storage device, data server and molecular memory.

A computer network may be used for allowing interaction between two or more electronic devices or modules, and includes any form of inter/intra enterprise environment such as the world wide web, Local Area Network (LAN), Wide Area Network (WAN), Storage Area Network (SAN) or any form of Intranet.

While only certain features of the invention have been illustrated and described herein, many modifications and changes will occur to those skilled in the art. It is, therefore, to be understood that the appended claims are intended to cover all such modifications and changes as fall within the true spirit of the invention.

I/we claim:

1. A method for building a situational judgment test implemented on non transitory computer storage media, the method comprising:
providing one or more test situations;
providing multiple options to address each of one or more test situations, wherein multiple options comprise at least one of a correct worst answer, and a correct best answer;
providing a selectable feature for selecting a worst response and a best response by a user; and
generating a score based on a selection of the correct worst answer,
wherein the test situation, the multiple options, and the selectable feature are provided using a user interface capable of user interaction.

2. The method of claim 1 further comprising generating a ‘+1’ score if the correct worst answer is selected for the worst response.

3. The method of claim 1 further comprising generating a ‘0’ score if the correct worst answer is not selected for the worst response.

4. The method of claim 1 further comprising generating a ‘−1’ score if the correct worst answer is selected as best response.

5. The method of claim 1 further comprising generating a ‘0’ score if the correct worst answer is not selected for the best response.

6. The method of claim 1 further comprising creating a weighted sum for the score generated based on the selection of the correct worst, wherein weights used for the weighted sum are derived from experts or by derived empirically.

7. The method of claim 1 further comprising generating a test report based on the score.

8. The method of claim 1 further comprising storing the test situation and multiple options in a test database.

9. A system for building and scoring a situational judgment test, the system comprising:
a test situation module comprising textual content for one or more test situations and associated multiple options to address each of one or more test situations, multiple options comprise at least one of a correct worst answer, and a correct best answer;
a user interaction module for providing the test situation, the multiple options and a selectable feature for selecting either a worst response or a best response by a user as a user response and configuring the user interaction module to receive the user response through one or more interactive features; and
a score generator module for generating a score based on a selection of the correct worst answer,
wherein the test situation module, the user interaction module and the score generator module are implemented on a non-transitory computer storage media.

10. The system of claim 9 wherein the score generator is configured for generating a ‘+1’ score if the correct worst answer is selected for the worst response.

11. The system of claim 9 wherein the score generator is configured for generating a ‘0’ score if the correct worst answer is not selected for the worst response.

12. The system of claim 9 wherein the score generator is configured for generating a ‘−1’ score if the correct worst answer is selected as best response.

13. The system of claim 9 wherein the score generator is configured for generating a ‘0’ score if the correct worst answer is not selected for the best response.

14. The system of claim 9 further comprising a reporting module for generating a test report based on the score.
